(19) United States
(12) Patent Application Publication
(10) Pub. No.: US 2024/0157474 A1
(43) Pub. Date: May 16, 2024

(54) METHOD AND DEVICE FOR WORKPIECE PROCESSING WITH A BROADENED LASER BEAM GUIDED BY A SCANNER OPTICAL UNIT

(71) Applicants: TRUMPF Laser- und Systemtechnik GmbH, Ditzingen (DE); TRUMPF Laser GmbH, Schramberg (DE)

(72) Inventors: Christoph Neugebauer, Kirchheim unter Teck (DE); Christoph Tillkorn, Villingendorf (DE); Gerhard Broghammer, Boesingen (DE); Daniel Corbean, Biel (CH)

(21) Appl. No.: 18/418,389

(22) Filed: Jan. 22, 2024

Related U.S. Application Data
(63) Continuation of application No. PCT/EP2022/070376, filed on Jul. 20, 2022.

(30) Foreign Application Priority Data
Jul. 23, 2021 (DE) 10 2021 119 195.5

(51) Int. Cl. B23K 26/064; B23K 26/08; B23K 26/082; B23K 26/36

(52) U.S. Cl. CPC B23K 26/064; B23K 26/082; B23K 26/0876; B23K 26/36

(57) ABSTRACT

A method for processing a workpiece with a laser beam includes guiding the laser beam by a scanner optical unit of an optical system. The laser beam has a linear cross section with an aspect ratio of a long side to a short side of more than 2 when impinging on the workpiece.

### CROSS REFERENCE TO RELATED APPLICATIONS

This application is a continuation of International Application No. PCT/EP2022/070376 (WO 2023/001897 A1), filed on Jul. 20, 2022, and claims benefit to German Patent Application No. DE 10 2021 119 195.5, filed on Jul. 23, 2021. The aforementioned applications are hereby incorporated by reference herein.

### FIELD

Embodiments of the present invention relate to a method and a device for processing a workpiece with a laser beam.

### BACKGROUND

It is known to deflect a laser beam with a scanner optical unit and guide it over a workpiece in order to process, in particular clean, the workpiece.

A disadvantage with the known methods or devices is that the scanner optical unit often needs to scan very rapidly in one direction. At least one mirror needs to be moved very rapidly to and fro in this case, so that the drive of the mirror reaches its loading limits and the processing speed of the overall method, or of the overall device, is limited.

### SUMMARY

Embodiments of the present invention provide a method for processing a workpiece with a laser beam. The method includes guiding the laser beam by a scanner optical unit of an optical system. The laser beam has a linear cross section with an aspect ratio of a long side to a short side of more than 2 when impinging on the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a method and a device for processing, here cleaning, a workpiece according to some embodiments;

FIG. 2a schematically shows a first scan raster of a laser beam on the workpiece according to some embodiments;

FIG. 2b schematically shows a second scan raster of the laser beam on the workpiece according to some embodiments;

FIG. 3a schematically shows a workpiece processed with a laser beam without an overlap of the scan lines according to some embodiments;

FIG. 3b schematically shows a workpiece processed with a laser beam with overlapping scan lines according to some embodiments;

FIG. 4 shows various aspect ratios of a cross section of a laser beam when impinging on a workpiece according to some embodiments;

FIG. 5a schematically shows a side view of a device for generating a laser beam according to some embodiments; and

FIG. 5b schematically shows a device of FIG. 5a in a side view rotated by 90° relative to the representation in FIG. 5a, according to some embodiments.

### DETAILED DESCRIPTION

Embodiments of the invention provide a method and a device which allow effective processing of a workpiece.

According to some embodiments, a method for processing a workpiece with a laser beam, wherein the laser beam is guided by a scanner optical unit of an optical system and wherein the laser beam has a linear or rectangular cross section with an aspect ratio of the long side to the short side of more than two when impinging on the workpiece.

The method according to embodiments of the invention makes it possible to overcome previous system limits, in particular to overcome the limited maximum speed of the scanner optical unit, so that the full power of the laser beam can be used on the workpiece.

The aspect ratio of the long side to the short side is preferably more than five, in particular more than 10.

The method according to embodiments of the invention is preferably used for cleaning, ablation, remelting and/or roughening.

The scanner optical unit may be configured in the form of a beam deflecting unit. For rapid processing of the workpiece, the scanner optical unit may have one or more galvanometer scanners.

Depending on the processing requirement, one or more passes of the laser beam may be carried out, in which case the process parameters may be the same or different during the passes.

The laser beam may impinge on the workpiece in the form of an individual spot or multifocally. As an alternative or in addition thereto, a plurality of laser beams and/or a plurality of optical systems may be provided.

The workpiece may be flat or curved.

In a preferred configuration, a movement of the laser beam takes place in a longitudinal direction and in a repeating scan transverse direction. In this case, the long side of the linear cross section preferably extends in the longitudinal direction.

The scan transverse direction is aligned transversely with respect to the longitudinal direction, and the movement of the laser beam preferably takes place more rapidly in the scan transverse direction than in the longitudinal direction. The speed of the movements (deflections) of the laser beam in the scan transverse direction may be more than ten times higher than in the longitudinal direction.

In the prior art, as mentioned in the introduction, the system limits are determined by the very rapidly repeating movements (deflections) in the scan transverse direction. For the movements in the scan transverse direction, at least one mirror of the scanner optical unit needs to be very rapidly accelerated, braked and accelerated again. In the described preferred embodiment of the invention, this movement in the scan transverse direction may be made slower by scanning with a wide cross section of the laser beam. Consequently, a large workpiece area can be processed with the laser beam with a relatively low speed in the scan transverse direction.

The movement in the longitudinal direction may take place by a forward feed of the workpiece relative to the scanner optical unit, by a scan movement of the scanner optical unit or by a combination of the two methods.

If the long side of the linear cross section extends in the repeating scan transverse direction, on the other hand, a temperature elevation may be achieved, in particular for cleaning purposes.

The long side of the linear cross section preferably extends perpendicularly to the scan transverse direction. The scan transverse direction and the short side in this case run perpendicularly to the longitudinal direction. This allows processing of the workpiece over the largest possible area with the slowest possible movement of the laser beam in the scan transverse direction.

More preferentially, the long side and the short side of the linear cross section respectively extend in the direction of principal axes of the optical system. The optical system may thereby be configured simply in terms of design.

The laser beam may be moved in the form of a raster over the workpiece. The linear cross section of the laser beam is in this case preferably oriented perpendicularly or parallel to the longitudinal direction. The method according to embodiments of the invention thereby allows efficient processing of the workpiece.

The scan lines may overlap (“positive overlap”) or be separate from one another (“negative overlap”). A positive overlap favours thorough cleaning, whereas a negative overlap may be used to detach coating parts, for example when stripping hairpins.

The laser beam may be guided before the scanner optical unit through a collimator and after the scanner optical unit through a focusing optical unit. The collimator in this case preferably shapes the laser beam asymmetrically (“anamorphic collimation”).

The collimator may have one or more aspherical lenses in order to initiate the optimal line shape for the workpiece processing.

The collimator may have at least two successively arranged collimator lenses, a first collimator lens shaping the laser beam in the direction of the long side of its cross section and a second collimator lens shaping the laser beam in the direction of the short side of its cross section. Various imaging ratios may be selected in the directions of the long side or short side, respectively, in order to shape the laser beam asymmetrically in cross section.

In a further preferred embodiment of the invention, the laser beam is pulsed.

The pulses may be applied overlapping (“positive pulse overlap”) or separately from one another (“negative pulse overlap”).

Preferably, a pulsed laser beam is used when the long side of the linear cross section of the laser beam is aligned on the workpiece surface transversely, in particular perpendicularly, to the repeating movement in the scan transverse direction. Despite a reduced speed of the movement of the laser beam in the scan transverse direction, the workpiece can then be processed with a high pulse rate. Furthermore, despite a defined pulse overlap, a large workpiece surface can be processed effectively with a low forward feed rate. Process parameters that have been determined for large areas may in this case be applied better to narrow areas since, according to embodiments of the invention, a lower scan speed is needed for a comparable pulse overlap.

The pulse rate is preferably between 1 kHz and 4 MHz.

The laser beam may be introduced into the optical system via a fibre-optic cable. The fibre-optic cable preferably opens into the collimator of the optical system. The fibre-optic cable may have a glass fibre. The fibre cross section of the fibre-optic cable is preferably circular or rectangular.

In a preferred configuration of the laser beam, the latter has

a) a wavelength of between 300 nm and 380 nm, between 500 nm and 550 nm or between 800 nm and 1200 nm;

b) a fluence of between 0.1 J/cm² and 40 J/cm²;

c) a beam quality M² of between 1 and 1.6 in single mode or of up to 100 or more in multimode; and/or

d) a gaussian or top-hat profile in cross section.

It should be understood here that the beam quality depends crucially on the diameter of the fibre-optic cable guiding the laser beam.

Preferentially, a top-hat profile is used in the case of a pulsed laser beam in order to avoid central intensity elevations and therefore elevated energy inputs.

In a preferred configuration of the workpiece, the latter has

a) a metallic material, such as an aluminium alloy, a stainless steel, a construction steel or copper, or a nonmetallic material, such as a ceramic, glass or a crystalline material, as its basic material;

b) a powder coating, a dip coating, a film and/or a spray coating as a coating; and/or

c) grease, oil, a silicone, cooling lubricant, an oxide, an eloxal layer and/or powder deposits as the substance to be cleaned.

Embodiments of the invention also provide a device for processing a workpiece with a laser beam, in particular by a device for carrying out a method as described here. The device has an optical system with a scanner optical unit, by which the laser beam can be guided. The optical system is configured to shape the laser beam in such a way that it has a linear cross section with an aspect ratio of the long side to the short side of more than two when impinging on the workpiece.

The device may have an axis system in order to move the scanner optical unit over large areas.

The device preferably has a fibre-optic cable for supplying the laser beam.

The device may have a collimator upstream of the scanner optical unit for asymmetric shaping of the laser beam.

The device may have a collimator assembly, the collimator being part of the collimator assembly. The collimator assembly may be configured modularly, so that the collimator assembly can be replaced easily in order to be able to adapt the aspect ratio of the laser beam on the workpiece surface simply to a process. The collimator assembly may have a connection in which the fibre-optic cable is received.

The collimator may have an aspherical collimator lens or a combination of aspherical collimator lenses, in order to generate the optimal laser shape.

For individual collimation of the laser beam, the collimator may be configured symmetrically with respect to two mutually perpendicular spatial directions. The two spatial directions in this case preferably correspond to principal axes of the optical system.

The device may have a spherical focusing optical unit downstream of the scanner optical unit.

Further advantages of the invention may be found in the description and the drawing. Likewise, according to the invention the features mentioned above and those yet to be explained further may respectively be used individually or together in any desired combinations. The embodiments shown and described should not be understood as an exhaustive list, but rather are of an exemplary character for outlining the invention.

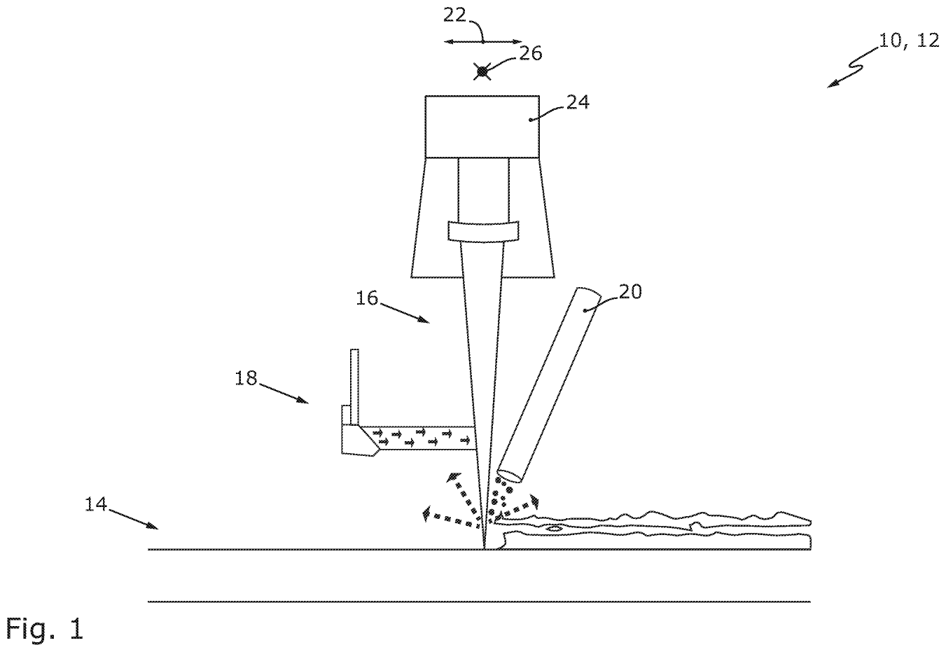

FIG. 1 shows a device 10 according to embodiments of the invention for carrying out a method 12 according to embodiments of the invention. A workpiece 14 is in this case processed, here cleaned, with a laser beam 16. In order to assist the processing, a cross jet 18 may be provided. As an alternative or in addition thereto, a suction apparatus 20 may be provided.

The processing of the workpiece 14 takes place in the longitudinal direction 22. The movement of the laser beam 16 in the longitudinal direction 22 may take place by deflection of the laser beam 16 in a scanner optical unit 24 and/or by a forward feed of the scanner optical unit 24 relative to the workpiece 14.

In addition to the movement of the laser beam 16 in the longitudinal direction 22, the laser beam 16 is moved transversely, here perpendicularly (i.e. into and out of the plane of the paper in FIG. 1), to the longitudinal direction 22. This movement in the scan transverse direction 26 is carried out by the scanner optical unit 24. The movement takes place more rapidly, often more than 2 times faster, more than 5 times faster or more than 10 times faster, in the scan transverse direction 26 than in the longitudinal direction 22. The movement of the scanner optical unit 24 in the scan transverse direction 26 is therefore generally the limiting factor of the device 10, or of the method 12, when processing the workpiece 14. One or more drive(s) (not shown) for moving one or more minors (not shown) of the scanner optical unit 24 in order to move the laser beam 16 in the scan transverse direction 26 may overheat, while one or more drive(s) (not shown) for moving one or more mirrors (not shown) of the scanner optical unit 24 in order to move the laser beam 16 in the longitudinal direction 22 is/are not being fully utilised. The device 10 according to embodiments of the invention, or the method 12 according to embodiments of the invention, remedy this, as will be explained below.

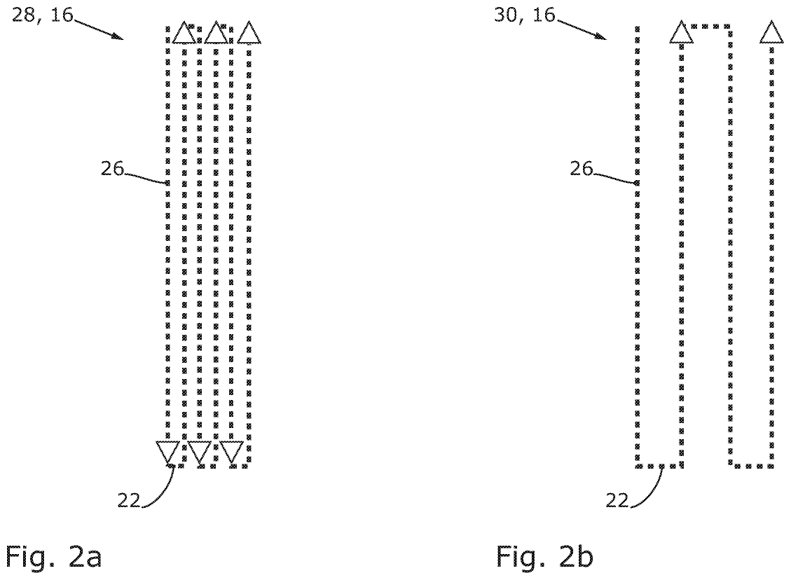

FIGS. 2a and 2b show a movement of the laser beam 16 in a first scan raster 28 and in a second scan raster 30. The scanning takes place in the longitudinal direction 22 and in the scan transverse direction 26. It may be seen from a comparison of FIGS. 2a, b that in the case of the second scan raster 30, the ratio of the movement of the laser beam 16 in the scan transverse direction 26 to its movement in the longitudinal direction 22 is much more balanced than for the first scan raster 28. In the second scan raster 30, the same area can in this case be covered with the laser beam 16 if it has an asymmetric shape in cross section.

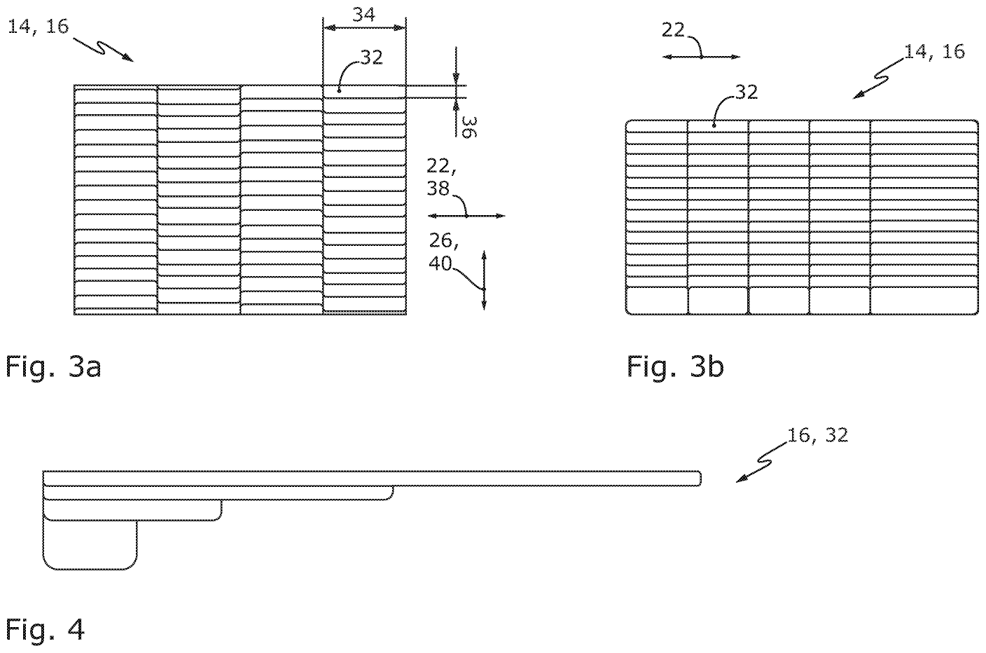

FIG. 3a shows a workpiece 14 processed by the laser beam 16, FIG. 3a representing concatenated cross sections 32 of the laser beam 16 when impinging on the workpiece 14. In FIG. 3a, one cross section 32 is provided with a reference sign for reasons of clarity. The cross section 32 has a long side 34 and a short side 36. It can be seen from FIG. 3a that the long side 34 is significantly longer than the short side 36. In this way, a large area of the workpiece 14 can be covered with a balanced ratio of the movement of the laser beam 16 in the scan transverse direction 26 to the movement of the laser beam 16 in the longitudinal direction 22.

The long side 34 may also, as an alternative to the representation shown in FIG. 3a, extend in the scan transverse direction 26. In this way, a strong temperature elevation may be achieved, preferably for cleaning purposes.

The long side 34 and the short side 36 preferably extend respectively in the direction of principal axes 38, 40 of the device 10 (see FIG. 1).

FIG. 3b shows concatenated cross sections 32 of the laser beam 16 in a similar way to FIG. 3a, the cross sections 32 overlapping. In this way, intensive processing, here cleaning, of the workpiece 14 may be achieved. As an alternative to the overlap shown in FIG. 3b, the cross sections 32 may also be spaced apart from one another (negative overlap, not shown), in the longitudinal direction 22. In this way stripping off coating parts (not shown) may be achieved.

FIG. 4 shows various cross sections 32 of the laser beam 16. With different aspect ratios according to embodiments of the invention. Preferred aspect ratios are between 1:2 (short side 36:long side 34, see FIGS. 3a) and 1:13 (short side 36:long side 34).

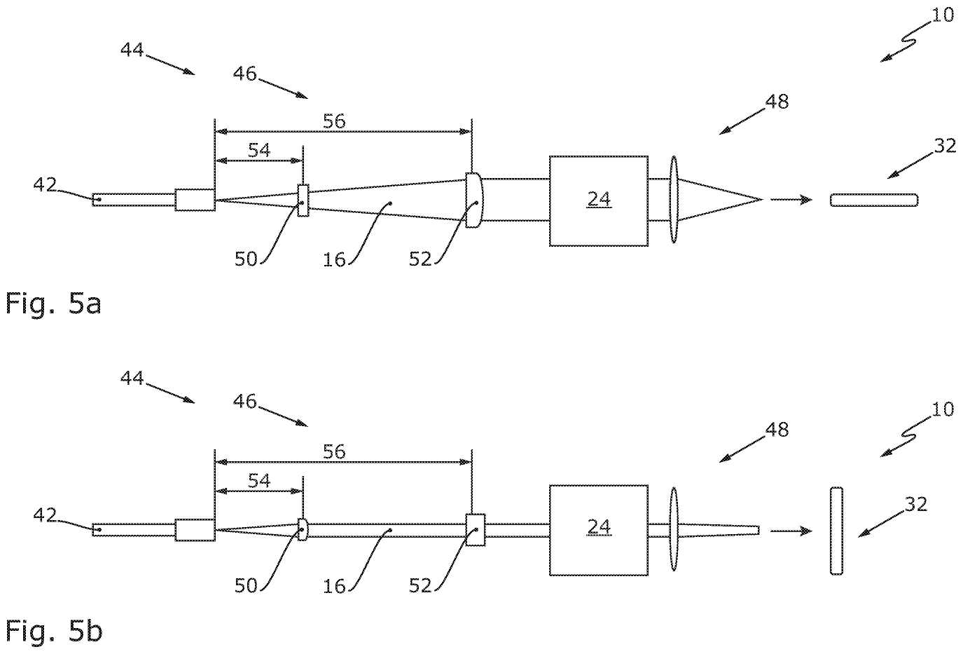

FIGS. 5a, 5b show the device 10 for laser beam processing with a laser beam 16 which is asymmetrical in cross section 32. The laser beam 16 may be guided into an optical system 44 by a fibre-optic cable 42. The optical system 44 may have a collimator 46, the scanner optical unit 24 and a focusing optical unit 48. The collimator 46 may have a first collimator lens 50 and a second collimator lens 52. The first collimator lens 50 may have a shorter focal length 54 than the second collimator lens 52 (see focal length 56) in order to shape the laser beam 16 asymmetrically.

As described above, embodiments of the invention relate to a device 10 and a method 12 for processing a workpiece 14 with a laser beam 16. The laser beam 16 has a preferably rectangular cross section 32 with a long side 34 and a short side 36 on the surface of the workpiece 14. The laser beam 16 is guided by a scanner optical unit 24 in which it is deflected at least in a scan transverse direction 26. The long side 34 is preferably aligned at an angle of between 80° and 100°, in particular at an angle of 90°, with respect to the scan transverse direction 26 in order to be able to cover a large surface of the workpiece 14 with few movements of the scanner optical unit 24 in the scan transverse direction 26. The asymmetric beam shaping may be carried out by two successively arranged collimator lenses 50, 52 with different focal lengths.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 device
12 method
14 workpiece
16 laser beam
18 cross jet
20 suction apparatus
22 longitudinal direction
24 scanner optical unit
26 scan transverse direction
28 first scan raster
30 second scan raster
32 cross section
34 long side
36 short side
38 principal axis
40 principal axis
42 fibre-optic cable
44 optical system
46 collimator
48 focusing optical unit
50 first collimator lens
52 second collimator lens
54 focal length of the first collimator lens 50
56 focal length of the second collimator lens 52

1. A method for processing a workpiece with a laser beam, the method comprising:
guiding the laser beam by a scanner optical unit of an optical system, wherein the laser beam has a linear cross section with an aspect ratio of a long side to a short side of more than 2 when impinging on the workpiece.

2. The method according to claim 1, wherein the aspect ratio of the long side to the short side is more than 5 when impinging on the workpiece.

3. The method according to claim 1, wherein the laser beam moves in a longitudinal direction and a repeating scan transverse direction, the scan transverse direction being aligned transversely with respect to the longitudinal direction, a movement speed of the laser beam in the scan transverse direction being greater than in the longitudinal direction, and the long side of the linear cross section extending in the longitudinal direction.

4. The method according to claim 3, wherein the long side of the linear cross section extends perpendicularly to the scan transverse direction.

5. The method according to claim 3, wherein the long side of the linear cross section and the short side of the linear cross section respectively extend in directions of principal axes of the optical system.

6. The method according to claim 1, wherein the laser beam moves in a raster form over the workpiece.

7. The method according to claim 1, wherein the laser beam is guided before the scanner optical unit through a collimator and after the scanner optical unit through a focusing optical unit, the collimator shaping the laser beam asymmetrically.

8. The method according to claim 1, wherein the laser beam is pulsed.

9. The method according to claim 1, wherein the laser beam is introduced into the optical system via a fibre-optic cable.

10. The method according to claim 1, wherein the laser beam has a wavelength of between 300 nm and 380 nm;
a fluence of between 0.1 J/cm² and 40 J/cm²;
a beam quality M² of between 1 and 1.6 in single mode or of up to 100 or more in multimode; and/or
a gaussian or top-hat profile in cross section.

11. The method according to claim 1, wherein the workpiece has
a metallic material or a nonmetallic material as a basic material;
a powder coating, a dip coating, a film and/or a spray coating as a coating; and/or
grease, oil, a silicone, cooling lubricant, an oxide, an eloxal layer and/or powder deposits as a substance to be cleaned.

12. A device for processing a workpiece with a laser beam, for carrying out a method according to claim 1, wherein the device comprises the optical system with the scanner optical unit, wherein the laser beam is guided by the scanner optical unit, and wherein the optical system is configured to shape the laser beam so that the laser beam has a linear cross section with the aspect ratio of the long side to the short side of more than 2 when impinging on the workpiece.

13. The device according to claim 12, wherein the device comprises a collimator upstream of the scanner optical unit for asymmetric shaping of the laser beam.

14. The device according to claim 13, wherein the collimator, for individual collimation of the laser beam, is configured symmetrically with respect to two mutually perpendicular spatial directions.

15. The device according to one of claim 12, wherein the device comprises a spherical focusing optical unit downstream of the scanner optical unit.
